(19) United States
(12) Patent Application Publication
(10) Pub. No.: US 2018/0182261 A1
(43) Pub. Date: Jun. 28, 2018

(54) Real Time Car Driving Simulator

(71) Applicant: IOTMOTIVE LTD., Jerusalem (IL)

(72) Inventors: Ygdal Naouri, Jerusalem (IL); Eliyahu Sivaks, Jersusalem (IL)

(21) Appl. No.: 15/895,843

(22) Filed: Feb. 13, 2018

Related U.S. Application Data
(63) Continuation-in-part of application No. 14/753,151, filed on Jun. 29, 2015, now abandoned.
Application No. 14/753,151 is a continuation of application No. PCT/US2014/045249, filed on Jul. 2, 2014.

(51) Int. Cl. G09B 19/16

(52) U.S. Cl. CPC G09B 19/167

(57) ABSTRACT

A driving simulator, comprises a processor; a video camera arranged on an actual vehicle and that provides videos of scenes in front of the actual vehicle to said processor; wherein said actual vehicle is controllable by control components, wherein said processor is configured to process said videos of scenes into processed videos, a monitor coupled to said processor, said monitor being configured said processed videos, a user interface coupled to said processor, said user interface being configured to enable simulating control of a movement of the actual vehicle based on processed videos displayed by the monitor, wherein said processed videos reflect a delta between data (DREAL) representative of controls of the control components of the actual vehicle for controlling the actual movement of the vehicle, and data representative of controls of said user interface for simulating control of the movement of the actual vehicle (DSIM).

### CROSS-REFERENCE TO RELATED APPLICATIONS

This application is a continuation-in-part of U.S. patent application Ser. No. 14/753,151 filed on Jun. 29, 2015, entitled “Real Time Car Driving Simulator,” which claims priority to PCT International Application No. PCT/US2014/045249 filed on Jul. 2, 2014, entitled “Real Time Car Driving Simulator,” both of which applications are incorporated herein by reference in their entirety.

### BACKGROUND OF THE INVENTION

The present invention relates generally to in-car entertainments and/or to in-vehicle infotainments (a.k.a. IVI) and more specifically it relates to a real-time driving simulator system for providing to the passengers of a vehicle the feeling they are currently the driver of the vehicle. It relates also to the use of augmented reality (a.k.a. AR) for the learning of car driving by car passengers.

WO 00/43093 describes an educational and toy-simulator installed in the car in front of the child's car seat aimed at developing children's skills in the techniques of car-driving and traffic regulations as well as satisfying their need for playing. The supporter (1) places the simulator board (2) in front of the child in accordance with the structural design of the child's car seat and the car as well as with the side of the child. On the front of the simulator board (2) toy equivalents of the operators and signals of car-driving (3, . . . 14), while inside the simulator board equipment enabling their electric operation are placed. A pedal simulator (23) can be connected to the simulator board (2) or the supporter (1) simulating the pedals of the car.

### BRIEF SUMMARY OF THE INVENTION

The invention generally relates to an in-car entertainment and/or to in-vehicle infotainments (a.k.a. IVI) which includes a video camera unit (a.k.a. CAM) (10), an inertial measurement unit (a.k.a. IMU) (20), one or more user interface(s) (a.k.a. U1) (30), a processing unit (a.k.a. PU) or processor (40), and one or more monitor(s) (50). Monitors 50 may be any display device of any device that includes or is capable of providing a display. Thus, a monitor includes a device that does not itself include a screen on which content is displayed but rather generates a projected display, e.g., a heads-up display system.

In particular, according to some embodiments, a real time captured video is turned into an interactive experience such as a driving simulator. According to some embodiments, the real time video is captured from a a camera located in a real vehicle, and processed into a real time driving simulator which is output to a display visible by a user. For example, a simulated vehicle is provided in the driving simulator, and the user can control this simulated vehicle based on commands that he provides to the driving simulator. The simulated vehicle evolves in a scene which is constructed based on the real time captured video after it has been processed. Thus, the user can try to control the simulated vehicle in order to mimic the behaviour of the real vehicle.

If the user provides commands which differ (“delta”) from the real commands provided by the actual driver of the vehicle, the simulated vehicle should see a scene which is different from the real time video captured from the actual vehicle.

Various smart processing can be performed in order to reflect a delta between data representative of the commands provided by the user and data representative of the actual commands provided by the actual driver of the vehicle. The nature of the delta (such as if the commands of the user are different in the direction imposed by the user to the simulated vehicle with respect to the actual direction of the vehicle) and the intensity of the delta (such as if the commands provided by the user differ from the commands provided by the actual driver in the intensity/amplitude) can be reflected using various smart processing, therefore providing a unique and innovative driving simulation and experience.

According to some embodiments, it is possible to handle both a real time video and commands provided by the user on the driving simulator to provide a display which reflects the commands provided by the user on the real time video itself, after this real time video has been processed. Although the content of the real time video cannot be predicted in advance, and the commands of the user of the driving simulator cannot be predicted in advance, according to some embodiments, it is possible to create a driving simulation which provides a feeling to the user of the driving simulator that he is currently driving the actual vehicle, by providing a processed video in real time or quasi real time.

According to some embodiments, visual effects can be superimposed on the real time video. According to some embodiments, at least part of the images of the real time video can be processed and manipulated to display various scenarios reflecting the commands of the user of the driving simulator. According to some embodiments, collision with obstacles, overtaking of vehicles, etc. can be inserted within the processed video.

According to some embodiments, these various scenarios can be displayed on the real time video after its processing although they do not appear in the real time video since the actual driver of the vehicle does not encounter these scenarios. For example, according to some embodiments, the actual vehicle is avoiding an obstacle, while the user of the driving simulator did not provide adapted commands to avoid the obstacle, therefore triggering the processing of the real time video to display a collision with the obstacle. These examples are however not limitative.

According to some embodiments, there is provided a driving simulator, comprising a processing unit, wherein said processing unit is coupled to a video camera arranged on an actual vehicle and that provides videos of scenes in front of the actual vehicle to said processor; wherein said actual vehicle is controllable by control components, wherein said processing unit is configured to process said videos of scenes into processed videos, wherein said processing unit is coupled to a monitor, said monitor being configured to display said processed videos, wherein said processing unit is coupled to a user interface, said user interface being configured to enable simulating control of a movement of the actual vehicle based on processed videos displayed by the monitor, wherein said processed videos reflect a delta between data (DREAL) representative of controls of the control components of the actual vehicle for controlling the actual movement of the vehicle, and data representative of controls of said user interface for simulating control of the movement of the actual vehicle (DSIM), wherein the processing unit is configured to associate to each frame or subset of frames of the videos of scenes a real position and a real speed of the actual vehicle, if DSIM are representative of a simulated position of the actual vehicle which correspond to a real position of the actual vehicle, compare a simulated speed of the actual vehicle with a real speed of the simulated vehicle at said simulated position, and based on this comparison, modify the frame rate of the videos of scenes to provide said processed videos. According to some embodiments, the processing unit is configured to perform at least one of zooming in the videos of scenes and zooming out the videos of scenes depending on said delta. According to some embodiments, the processing unit is configured to adjust a direction of zooming based on a detection of road portions in the videos of scenes. According to some embodiments, the processing unit is configured to detect advertisement present in the videos of scenes, and to replace them in the processed videos by other images depending on a profile associated to a user of the driving simulator. According to some embodiments, the driving simulator is configured to obtain data from a second driving simulator, wherein the driving simulator is configured to complete the processed videos with video of scenes provided by the second driving simulator located in a zone comprising said simulated position. According to some embodiments, the driving simulator is configured to obtain data from a second driving simulator, wherein the driving simulator is configured to display a simulated vehicle in the processed videos based on said data and reflecting a simulated vehicle associated to said second driving simulator.

According to some embodiments, there is provided a driving simulator, comprising a processor, wherein said processor is coupled to a video camera arranged on an actual vehicle and that provides videos of scenes in front of the actual vehicle to said processor; wherein said actual vehicle is controllable by control components, wherein said processor is configured to process said videos of scenes into processed videos, wherein said processor is coupled to a monitor, said monitor being configured to display said processed videos, wherein said processor is coupled to a user interface, said user interface being configured to enable simulating control of a movement of the actual vehicle based on processed videos displayed by the monitor, wherein said processed videos reflect a delta between data (DREAL) representative of controls of the control components of the actual vehicle for controlling the actual movement of the vehicle, and data representative of controls of said user interface for simulating control of the movement of the actual vehicle (DSIM), wherein the processing unit is configured to detect one or more potential obstacles present in the videos of scenes, wherein if DSIM are associated with a simulated position of the actual vehicle which corresponds to a position of at least one of the detected obstacles, the processing unit is configured to integrate within the processed videos a simulation of a collision with said at least one detected obstacles.

According to some embodiments, if condition (i), (ii) or (iii) is met; (i) DSIM are associated with a simulated motion on a road lane different from an actual road lane on which the actual vehicle is travelling; (ii) DSIM are associated with a simulated motion from a first road lane to a second road lane, whereas the actual vehicle does not change its road lane, or changes its road lane in a different way; (iii) DSIM are associated with a simulated motion comprising overtaking a vehicle present in the videos of scenes, whereas the actual vehicle is not overtaking this vehicle, the processing unit is configured to modify the videos of scenes in order to produce said processed videos, said modification comprising reflecting, using image processing techniques, in the processed videos, said condition (i), (ii), or (iii). According to some embodiments, the driving simulator is configured to obtain data from a second driving simulator, wherein the driving simulator is configured to display a simulated vehicle in the processed videos based on said data and reflecting a simulated vehicle associated to said second driving simulator. According to some embodiments, the processing unit is configured to perform at least one of zooming in the videos of scenes and zooming out the videos of scenes depending on said delta. According to some embodiments, the processing unit is configured to adjust a direction of zooming based on a detection of road portions in the videos of scenes. According to some embodiments, the processing unit is configured to detect advertisement present in the videos of scenes, and to replace them in the processed videos by other images depending on a profile associated to a user of the driving simulator.

According to some embodiments, there is provided a driving simulator, comprising a processor, wherein said processor is coupled to a video camera arranged on an actual vehicle and that provides videos of scenes in front of the actual vehicle to said processor; wherein said actual vehicle is controllable by control components, wherein said processor is configured to process said videos of scenes into processed videos, wherein said processor is coupled to a monitor, said monitor being configured to display said processed videos, wherein said processor is coupled to a user interface, said user interface being configured to enable simulating control of a movement of the actual vehicle based on processed videos displayed by the monitor, wherein said processed videos reflect a delta between data (DREAL) representative of controls of the control components of the actual vehicle for controlling the actual movement of the vehicle, and data representative of controls of said user interface for simulating control of the movement of the actual vehicle (DSIM), wherein the processing unit is configured to detect one or more potential obstacles present in the videos of scenes, wherein the driving simulator is configured to exchange data with a second driving simulator, and wherein if DSIM are associated with a simulated position of the actual vehicle which correspond to scenes which are not currently available in said videos of scenes, the driving simulator is configured to complete the processed videos with data provided by the second driving simulator. According to some embodiments, if condition (i), (ii) or (iii) is met; (i) DSIM are associated with a simulated motion on a road lane different from an actual road lane on which the actual vehicle is travelling; (ii) DSIM are associated with a simulated motion from a first road lane to a second road lane, whereas the actual vehicle does not change its road lane, or changes its road lane in a different way; (iii) DSIM are associated with a simulated motion comprising overtaking a vehicle present in the videos of scenes, whereas the actual vehicle is not overtaking this vehicle, the processing unit is configured to modify the videos of scenes in order to produce said processed videos, said modification comprising reflecting, using image processing techniques, in the processed videos, said condition (i), (ii), or (iii). According to some embodiments, if DSIM are associated with a simulated motion comprising overtaking a given vehicle present in the videos of scenes on a first side, and the actual vehicle is overtaking this given vehicle on an second side different from the first side, the driving simulator is configured to simulate in the processed videos a view of the given vehicle on the first side based on the view of the given vehicle on the second side. According to some embodiments, the driving simulator is configured to obtain data from a second driving simulator, wherein the driving simulator is configured to display a simulated vehicle in the processed videos based on said data and reflecting a simulated vehicle associated to said second driving simulator. According to some embodiments, the processing unit is configured to perform at least one of zooming in the videos of scenes and zooming out the videos of scenes depending on said delta. According to some embodiments, the processing unit is configured to adjust a direction of zooming based on a detection of road portions in the videos of scenes. According to some embodiments, the processing unit is configured to detect advertisement present in the videos of scenes, and to replace them in the processed videos by other images depending on a profile associated to a user of the driving simulator. According to some embodiments, the driving simulator is, configured to perform at least one of shifting right the videos of scenes, shifting left the videos of scenes, shifting up the videos of scenes, shifting down the videos of scenes, and inserting indicators on the videos of scenes (based in particular on said delta).

According to some embodiments, there is provided a driving simulator for a moving vehicle having an operator seat and at least one passenger seat, comprising a processor; a video camera arranged on the vehicle and that provides videos of scenes in front of the vehicle to said processor; a monitor coupled to said processor, said monitor being configured to display videos based on videos of scenes provided by said video camera, wherein said monitor is configured to be visible from said at least one passenger seat; a user interface coupled to said processor, said user interface being configured to enable simulating control of movement of the vehicle based on the videos being displayed on said monitor, wherein said simulation does not control an actual movement of the vehicle; and a vehicle control component position system arranged on the vehicle and coupled to said processor, said vehicle control component position system providing output related to position of control components of the vehicle, said control components allowing control of the actual movement of the vehicle, wherein said processor is configured to analyze the output of said control components of the vehicle provided by said vehicle control component position system and the simulated control of the movement of the vehicle provided through at least said user interface, to enable output indicative of accuracy of the simulation of the control of the movement of the vehicle relative to actual control of the movement of the vehicle using said control components, wherein said processor is configured to process, using image processing techniques, videos of scenes in front of the vehicle, to enable the output indicative of the accuracy of the simulation to be displayed, on the monitor, on the processed videos of scenes, wherein said displaying of the output indicative of the accuracy of the simulation on the monitor comprises displaying a feedback which reflects a delta between data representative of controls of said control components of the vehicle for controlling the actual movement of the vehicle, and data representative of controls of said user interface for simulating control of the movement of the vehicle, and wherein said feedback comprises at least one of zooming in the videos of scenes and zooming out the videos of scenes depending of said delta. According to some embodiments, said vehicle control component position system comprises an inertial measurement unit that obtains inertial data about the vehicle, the position of the control components being derived or estimated from the inertial data by said processor, the inertial data including one or more of velocity of the vehicle and acceleration of the vehicle. According to some embodiments, said processor analyzes the position of the control components of the vehicle derived or estimated by said processor based on the output provided by said vehicle control component position system and the simulated control of the movement of the vehicle using said user interface by estimating positions of a steering wheel, an accelerator pedal and a brake pedal of the vehicle from the inertial data obtained from said inertial measurement unit and comparing the estimated positions to the positions of a simulated steering wheel, a simulated accelerator pedal and a simulated brake pedal being controlled using said user interface, wherein said processor is configured to compute said delta based on said comparison. According to some embodiments, said vehicle control component position system comprises position sensors associated with the control components that directly provide position of the control components to said processor, the control components that are including at least one of a steering wheel of the vehicle, an accelerator pedal of the vehicle and a brake pedal of the vehicle. According to some embodiments, said processor analyzes the position of the control components provided by said vehicle control component position system and the simulated control of the movement of the vehicle using said user interface by estimating simulated positions of a steering wheel, an accelerator pedal and a brake pedal controlled using said user interface and comparing the estimated simulated positions to the positions of the steering wheel, the accelerator pedal and the brake pedal provided by said vehicle control component position system, wherein said processor is configured to compute said delta based on said comparison. According to some embodiments, said processor is configured to insert visual and/or audio indicators in the videos being displayed on said monitor based on said delta. According to some embodiments, said vehicle control component position system and said processor are housed in a common housing on the vehicle. According to some embodiments, said vehicle control component position system is wirelessly coupled to said processor. According to some embodiments, said processor is apart from the vehicle. According to some embodiments, the driving simulator further comprises at least one additional monitor coupled to said processor, each of said at least one additional monitor being configured to display the videos provided by said video camera when in a location visible from at least one other passenger seat; and at least one additional user interface accessible from at least one other passenger seat, said at least one user interface being configured to enable simulating control of movement of the vehicle based on the videos being displayed on a respective one of said at least one additional monitor, said processor being configured to analyze the position of said control components of the vehicle provided by said vehicle control component position system and the simulated control of the movement of the vehicle provided through at least said at least one additional user interface, to enable output indicative of accuracy of the simulation of the control of the movement of the vehicle using said additional user interface relative to actual control of the movement of the vehicle using said control components. According to some embodiments, said feedback further comprises at least one of shifting right the videos of scenes, shifting left the videos of scenes, shifting up the videos of scenes, shifting down the videos of scenes, and inserting indicators on the videos of scenes. According to some embodiments, said processor is configured to insert visual and/or audio indicators in the videos being displayed on said monitor based on accuracy of the simulation of the control of the movement of the vehicle. According to some embodiments, said processor is configured to insert visual and/or audio indicators in the videos being displayed on said monitor based on content of the videos. According to some embodiments, said user interface comprises a rotary encoder, a steering wheel attached to the rotary encoder, a position sensor-equipped accelerator pedal, and a position sensor-equipped brake pedal. According to some embodiments, said processor is configured to perform at least one of said zooming in the videos of scenes, in response to a slower velocity of the actual movement of the vehicle with respect to the velocity of the simulated movement of the vehicle, and said zooming out of the videos of scenes, in response to a higher velocity of the actual movement of the vehicle with respect to the velocity of the simulated movement of the vehicle. According to some embodiments, said user interface comprises a portable communications device wirelessly coupled to said processor. According to some embodiments, said video camera is embodied in an additional portable communications device and is wirelessly coupled to said processor. According to some embodiments, said video camera is embodied in a portable communications device and is wirelessly coupled to said processor. According to some embodiments, said user interface enables simulating control of movement of the vehicle by converting directional and acceleration/deceleration commands entered via use of said user interface into simulated control of movement of the vehicle without actually controlling movement of the vehicle. According to some embodiments, said processor does not consider location of the vehicle when analyzing the output of said vehicle control component position system related to the position of the control components and the simulated control of the movement of the vehicle t using said user interface.

According to some embodiments, there is provided a non-transitory storage device readable by a machine, tangibly embodying a program of instructions executable by the machine to perform any of the operations described above, according to all possible embodiments.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a rear view of an exemplifying, non-limiting embodiment of the present invention.

FIG. 2 is a functional block diagram of the present invention that provides a visual understanding of the different functionalities involved and their inter-relationships.

FIG. 3 describes an embodiment of modifying the frame rate of the videos of scenes;

FIG. 3A describes a possible embodiment for performing the method of FIG. 3;

FIG. 4 describes an embodiment of detecting obstacles in the videos of scenes and processing the videos of scenes to reflect a collision;

FIG. 5 describes an embodiment of detecting differences between the simulated travelling direction or motion and the travelling direction or motion of the actual vehicle, for reflecting these differences in the processed videos of scenes;

FIG. 6 describes an embodiment of performing a smart zoom of the images;

FIGS. 7A-7B describes an embodiment of shifting the images;

FIG. 8 describes a network of driving simulators, which can exchange data;

FIG. 9 describes a method of using data received from other driving simulators;

FIG. 10 describes a method of using data received from one or more other driving simulators, to complete the processed videos of scenes.

### DETAILED DESCRIPTION OF THE PREFERRED EMBODIMENTS

The terms “processor” or “processing unit” as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), and an application specific integrated circuit (ASIC), etc.) capable of executing various data processing operations.

It can encompass a single processor or multiple processors, which may be located in the same geographical zone or may, at least partially, be located in different zones and may be able to communicate together.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

### Overview

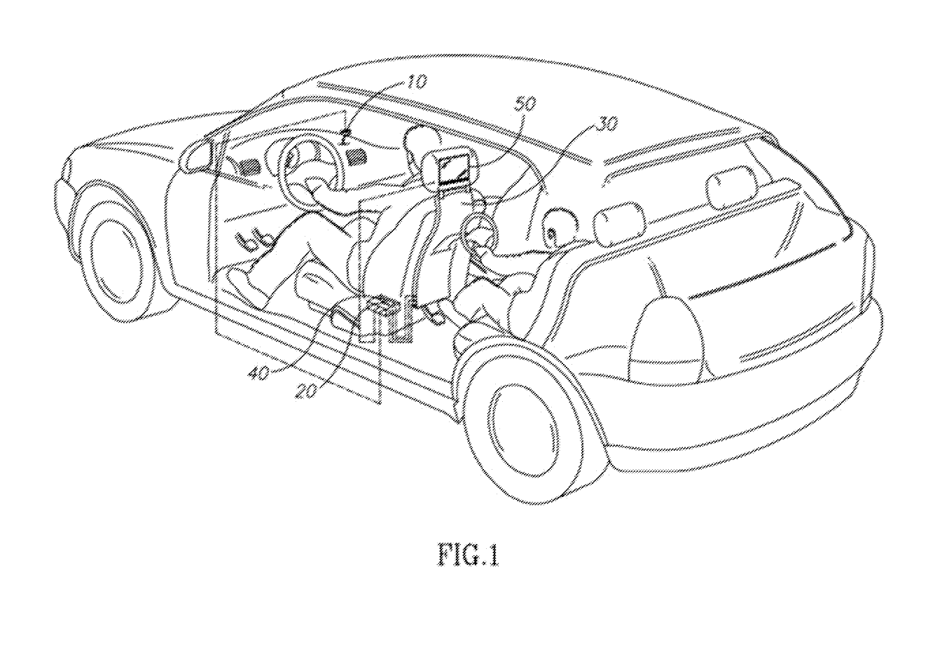

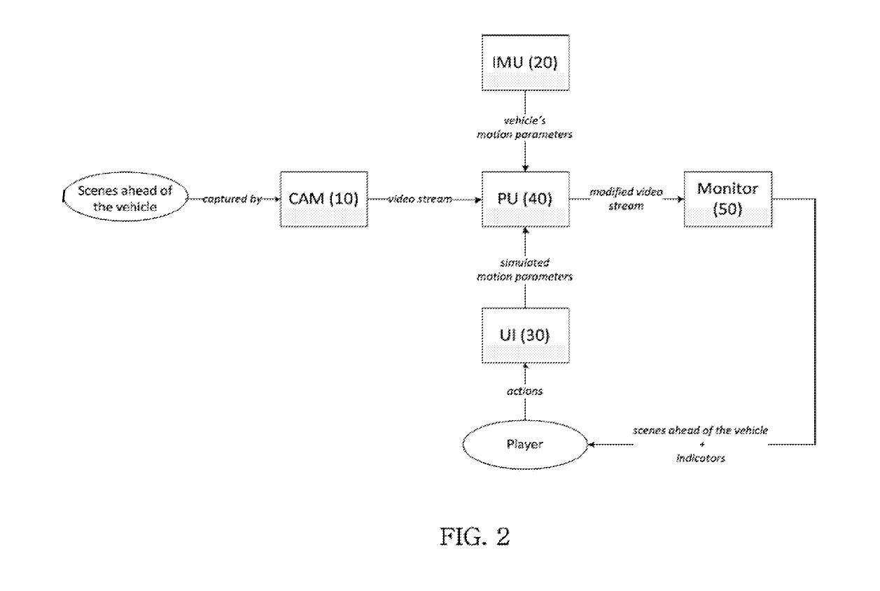

Turning now descriptively to the drawings, in which similar reference characters denote similar elements throughout the several views, FIGS. 1 and 2 illustrate a video camera unit

k.a. CAM (10), an inertial measurement unit a.k.a. IMU (20), user interface(s) a.k.a. U1(s) (30), a processing unit a.k.a. PU (40), and monitor(s) (50).

### Video Camera Unit (CAM)

A video camera (CAM 10) captures scenes ahead of the vehicle and transmits the encoded motion pictures as a streaming to the processing unit (40). There, the stream made of the scenes ahead of the vehicle is processed in real time and displayed on the monitor(s) (50) which is/are located in front of the car passengers. This gives the passengers the feeling they are watching the scenes ahead of the vehicle through the windshield of the car.

The CAM (10) is a digital video camera that encodes the scenes ahead of the vehicle and delivers in a streaming manner the digitized motion pictures to the processing unit (40), via a power and data link cable (e.g., USB cable).

The angle of view shall be wide enough to cover for the driver view through the vehicle windshield and beyond it. However, the front scenes displayed to the passengers on the monitor(s) have a narrower angle of view than what is recorded by the digicam. This allows to deviate and/or to narrow the view angle and to zoom in/out the scene for producing visual effects that will guide the passenger.

The sensitivity of the video camera (10) shall preferably be high enough to allow capturing the scenes ahead of the vehicle also in the night.

The CAM (10) is preferably mounted on the dashboard or on the windshield of the vehicle, and is fixed via an adhesive fastener for instance, or via any other conventional means for attaching or fixing.

The CAM (10) can alternatively be mounted on the inner roof of the vehicle or on the back of the rearview mirror or on any other location that allows capturing the vehicle front scene with an angle view sufficiently large. For instance, the CAM (10) can be mounted at the exterior front side of the vehicle, like it is done by car manufacturers for the reverse direction camera, at the vehicle back side.

Alternatively, for reducing the routing of cabling across the vehicle compartment, the power and data link cable running between the CAM (10) and the PU (40) can be entirely or partially replaced by an independent power source for the CAM (10) like a set of batteries for instance, and/or by a wireless transmitter from the CAM (10) to the PU (40).

Alternatively, an analog video camera can be used whereas the digitalization is performed by analog to digital converters inserted on the way toward the processing unit (40).

Alternatively, the video cam (10) built-in in a smartphone or a tablet can be used. An in-car smartphone holder (or tablet holder) is used for fixing the smartphone (or the tablet) onto the vehicle in a way that permits to capture the scenes ahead of the vehicle. The wireless transmission protocol built-in in the smartphone or tablet (e.g. Wi-Fi, Bluetooth, etc.) can be used to convey the scenes ahead of the vehicle to the IMU (20) (in case the IMU (20) built-in in the smartphone/tablet is not used). Otherwise, the power and wired data link cable of the smartphone or tablet can be used instead.

All the alternatives listed above to the CAM (10) and to the way to fix it to the vehicle are only examples, and are not excluding the use of any other existing possible embodiments as long as they provides the same functionality of capturing the scenes ahead of the vehicle.

### Inertial Measurement Unit (IMU)

An IMU (20) is used to calculate the instantaneous linear and angular acceleration/deceleration of the vehicle as well as its velocity, that is the motion parameters of the vehicle. Inertial data as used herein will therefore encompass, but is not limited to, the velocity of the vehicle which includes its speed and direction of travel, and acceleration of the vehicle.

The motion parameters are then processed by the processing unit (40) for estimating how well the driving actions taken by the vehicle driver are imitated by each of the passengers when they play through their respective user interface (30).

The motion parameters are continuously injected into the PU (40) via a power and data link cable (e.g. a USB cable) for estimating the position of the vehicle steering wheel and of the gas/brakes pedals. A gas pedal is also commonly referred to as an accelerator pedal. Generally, the steering wheel, accelerator pedal and brake pedal may be referred to as vehicle control components herein. The invention may be used with all three of these vehicle control components or a subset thereof, or possibly additional vehicle control components, e.g., a gear shift lever if a manual transmission car is to be simulated. Note that unlike in the common inertial measurement systems, the present invention does not require the knowledge of the vehicle's location, but only the instantaneous vehicle motion parameters.

Here too, for reducing the routing of cabling across the vehicle compartment, the power and data link cable running between the IMU (20) and the PU (40) can alternatively be entirely or partially replaced by an independent power source for the IMU (20) like a set of batteries for instance, and/or by a wireless transmitter from the IMU (20) to the PU (40).

Typically, a GPS (Global Positioning System) receiver is combined with a micro-controller for the retrieving of the vehicle's instantaneous motion parameters. But this is only one example since any other method can be used; such as algorithms for video motion detection applied in real time on the captured front scenes; or the combining or even the replacing of the GPS receiver with a 3-axis MEMS accelerometer, 3-axis MEMS gyroscope, 3-axis MEMS magnetometer, sensors of pressure and temperature, etc.; or by any other known method used for the same purpose.

The IMU (20) and the PU (40) can be enclosed into the same system case in which they can communicate via a system bus or any other on-board channel. This corresponds to the particular embodiment shown in FIG. 1 as an illustrated example.

Alternatively, the IMU (20) can be embedded in the built-in in-car processor provided by some car manufacturers.

Alternatively, the IMU (20) can be enclosed in a smartphone or a tablet, in which the built-in inertial and/or positioning sub-systems are combined with software applications for providing the required inertial measurement data. In such an embodiment, the CAM (10) and the IMU (20) might or might not be enclosed in the same smartphone or tablet. In case they are, the data conveyed to the PU (40) over the wired or wireless transmission channel shall combine and encode the instantaneous motion parameters together with the captured scenes ahead of the vehicle.

Alternatively, the IMU (20) can be replaced by an angle sensor fixed on the vehicle steering wheel and by position sensors fixed on the gas/brakes pedals of the vehicle.

Alternatively, the IMU (20) can be replaced by the outputs of the vehicle's built-in directional system and speedometer.

In the last two alternatives, the instantaneous positions of the steering wheel and of the gas/brakes pedals are directly measured, with no need to retrieve them from the vehicle's motion parameters.

All the alternative IMUs (20) listed above are just examples of IMU embodiments, and are not excluding the use of any other existing possible embodiments as long as they provide the same functionality of giving reliable estimations on the actions (and their intensity) currently taken by the car driver.

### User Interfaces(s) (UI)

Each passenger is equipped with his/her own user interface (30). It is used by the passenger for mimicking the driving actions currently taken by the car driver. For doing so, the passengers refer to the scenes ahead of the vehicle which are displayed on the monitor(s) (50) located in front of them. The passengers get visual aids (and/or audio aids) inserted into the images (and/or into the sound track) by the processing unit (40). They are referred generically as indicators as they can take any possible form.

In the preferred embodiment of the invention, the user interface is a simulator kit made of a simulator steering wheel attached to a rotary encoder, a simulator gas pedal, and a simulator brake pedal, which are both equipped with position sensors. In such an embodiment, a user interface (30) is a replication of the car driving station. This simulator kit is made of several components:

A simulator steering wheel which can be rotated by the player around its rotation axis, like the real steering wheel of a car. The current rotation angle of the simulator steering wheel relatively to an initial position is measured and encoded by a rotary encoder, and is transmitted in real time to the PU (40) over the power and data link cable (e.g. a USB cable). The angular rotation range of the simulator steering wheel may be more than 360 degrees, like for a real car's steering wheel. For safety for passengers in the rear seat, the rotation axis bar on which the steering wheel of the simulator is set can pivot toward the back side of the front seat in anticipation of a sudden deceleration of the vehicle, thus avoiding the colliding of the simulator's steering wheel with the player.

A simulator gas pedal which can be pushed/released by the player, like the real gas pedal of a car. The current position of the simulator gas pedal relatively to an initial position is measured and encoded by a position sensor, and is transmitted in real time to the PU (40) over a power and data link cable (e.g. a USB cable).

A simulator brakes pedal which can be pushed/released by the player, like the real brakes pedal of a car. The current position of the simulator brakes pedal relatively to an initial position is measured and encoded by a position sensor, and is transmitted in real time to the PU (40) over a power and data link cable (e.g. a USB cable).

The main components of the simulator kit are assembled together via a support and a fitter. The support is aimed to make the simulator's pedals and the simulator's steering wheel stand alone in some initial position, even if no one is playing with them. The fitter is aimed to adapt the position of the simulator's pedals and of the simulator's steering wheel to the tall of the player, who can be a child or an adult. The simulator's pedals and the simulator's steering wheel can be fixed on a thin booster seat or on a kind of saddle laid on the backrest of the vehicle front seat (as shown in FIG. 1). The simulator's pedals can be adjusted to the player's tall via some adjustable rigid strips, like it is done for the rider's legs over a horse saddle. The simulator's steering wheel can be adjusted to the player's tall by a telescopic bar fixed with pins.

Several alternative embodiments of the support and of the fitters do exist:

The simulator pedals and the simulator steering wheel can be fixed on a thin booster seat or on a kind of saddle laid on the vehicle back seat. As before, the simulator pedals can be adjusted to the player's tall via adjustable rigid strips and the steering wheel can be adjusted to the player's tall by a telescopic bar fixed with pins.

The supporter can be made of a box laid on the vehicle's back floor, on which the simulator pedals and simulator steering wheel are fixed via fixing bars. The adjuster in this case is made of the box lid which can be raised/lowered via pluggable pins for matching the player's tall. The rotary bar axe on which the simulator steering wheel is fixed can pivot back and forth in the aim to be adapted to the player's hands length. The bar position is then fixed via pluggable pins or any other adjustable aim.

The simulator kit (30) can also be provisioned and embedded within the back seats, in a non-removable manner.

As before, for reducing the routing of cabling across the vehicle compartment, the power and data link cable running between the U1 (30) and the PU (40) can be alternatively entirely or partially replaced by an independent power source for the U1 (30) like a set of batteries for instance, and/or by a wireless transmitter from the U1 (30) to the PU (40).

Alternatively, the user interface (30) can be made of one or several joysticks by which the player enters the driving actions he/she desires to take for mimicking the car driver, like vehicle's direction change and acceleration/deceleration.

Alternatively, the user interface can be replaced by a smartphone or a tablet held by the passenger. He/she has to turn, tilt, and/or move the smartphone or the tablet he/she holds to mimic the car driving actions.

It can be for instance that turning the smartphone or the tablet to the right as if it was a steering wheel is interpreted as if the passenger has turned a simulator steering wheel to the right, and vice versa for the left. Alternatively to the use of turning actions, tilting the smartphone or the tablet to the right around its vertical axis can be interpreted as if the passenger has turned a simulator steering wheel to the right, and vice versa for the left. Alternatively, moving in translation the smartphone or the tablet to the right can be interpreted as if the passenger has turned a simulator steering wheel to the right, and vice versa for the left. Any combination of the mentioned alternatives can be used in such an embodiment of the user interface.

Similarly, tilting the smartphone or the tablet forward around its horizontal axis can interpreted as if the passenger has pressed the gas pedal or released the brake pedal, and that tilting it backward is interpreted as if he/she has released the gas pedal or pressed the brake pedal. Alternatively to tilting actions, moving the smartphone in the forward direction is interpreted as if the passenger has pressed the gas pedal or released the brake pedal, and moving it in the rear direction is interpreted as if he/she has released the gas pedal or pressed the brake pedal.

In such an embodiment, the smartphone or tablet used for a user interface (30) may or may not be the same smartphone or tablet used for capturing the scenes ahead of the vehicle—the two options are possible. In such a case, the IMU (20) is preferably embedded in the smartphone or tablet which is used for capturing the scenes ahead of the vehicle, but it may also be embedded (and thus replicated) in the smartphone(s) or tablet(s) used for the user interface(s).

In such an embodiment, the U1 (30) may or may not be enclosed in the same smartphone or tablet together with the CAM (10) and/or the IMU (20). In case they are, the data conveyed to the PU (40) over the wired or wireless transmission channel shall combine and encode the user's playing actions together with the scenes ahead of the vehicle and/or with the instantaneous motion parameters.

All the alternative U1s (30) listed above are just examples of U1 embodiments, and are not excluding the use of any other existing possible embodiments as long as they provide the same functionality of entering into the system the player's actions he/she takes to mimic the car driver's driving actions.

For conciseness and for gaining in clarity when it comes to describe the object of the invention, the present document refers to the preferred embodiment of the user interface (30) (that is the simulator kit), but it does not exclude any other alternative user interface (30) mentioned above. Moreover, any other kind of existing user interface (30) can be used for this purpose as long as it provides a way for the user to enter directional and acceleration/deceleration commands as inputs into the system.

### Processing Unit (PU)

The processing unit (40) estimates the positions of the vehicle's steering wheel and of its gas/brakes pedals that are required to produce the vehicle motion parameters measured by the IMU (20). For each passenger separately, the PU (40) compares the estimated positions with the positions of his/her simulator's steering wheel, simulator gas pedal and simulator brake pedal in order to determine instantaneously how well each passenger succeeds to mimic the car driver.

The processing unit (40) shall preferably insert indicators which may be some visual aids in the images sent to the monitors (50) (and/or some audio aids in the sound track played by the monitors' speakers) in order to notify the player whether or not some driving action shall be taken. For instance if the player should increase the pressure he/she is currently applying on the simulator's gas pedal, the image can be shifted down and/or zoomed out, and/or a dial indicator added over the image can be shifted down. These are just few examples of all the possible indicators that may be inserted onto or beside the scenes ahead of the vehicle which are displayed by the monitor (50).

As being a generic term, the indicators represent in fact any effects and technics which are used to produce an augmented reality (AR) based upon real life imagery. It may for instance include the processing of the images in a way to produce an animation or a cartoon which is combined with reality's scenes.

The PU (40) typically consists of a micro-processor or of any device which has processing abilities and/or computing abilities and which can perform image processing tasks over a streaming video input. By such, a micro-controller sub-system, or any programmable device, or a dedicated silicon chip, or any combination between them can be used instead of a micro-processor.

The PU (40) performs the following tasks:

It estimates the position of the vehicle's steering wheel and of its gas/brakes pedals that are required at every instant to achieve the vehicle's motion parameters which are received from the IMU (20). The angular velocity is converted in a steering wheel position according to a predefined conversion scale. Similarly, the linear acceleration is converted in a position of the gas pedal. A small deceleration is converted in the release of the pressure on the gas pedal. A big deceleration is converted in a brakes pedal position according to a predefined conversion scale too.

It compares the positions of the vehicle's steering wheel and its gas/brakes pedals which were estimated in step 1, with the positions of the simulator's steering wheel and its gas/brakes pedals which are received from the simulator kits (30).

It inserts indicators to the streaming images received from the CAM (10).

It delivers the streaming images processed in step 3 to the monitors (50) over the power and data link cable.

The indicators for the vehicle's direction are inserted for each player separately, in proportion to the algebraic delta measured between the position of the vehicle's steering wheel and the position of the simulator's steering wheel of a passenger. If a player should turn the simulator steering wheel to the left to mimic the car driver, the image can for instance be shifted right to make the player feel that the vehicle derives to the right—until he/she takes the appropriate action. Inversely, if the player should turn the simulator steering wheel to the right to mimic the car driver, the image can for instance be shifted left to make the player feel that the vehicle derives to the left—until he/she takes the appropriate action.

Similarly, the indicators for the acceleration/deceleration of the vehicle are inserted for each player separately, in proportion to the algebraic delta measured between the position of the vehicle's gas/brakes pedals and the position of the simulator's gas/brakes pedals. If the player should increase the pressure he/she is applying on the simulator gas pedal, the image can for instance be shifted down and/or zoomed out, to make the player feel that the vehicle is slowing down—until he/she takes the appropriate action. Inversely, if to mimic the car driver the player should decrease the pressure he/she is applying on the simulator gas pedal and then start applying a pressure on the brakes pedal, the image can be for instance shifted up and/or zoomed in, to make the player feel that the vehicle is slowing down—until he/she takes the appropriate action.

In addition to (or instead of) shifting the image left/right and zooming the image up/down, indicators in the form of dials can be added onto or beside the streaming video.

The intensity of the indicators can also be proportional to the time that the delta between the positions of the vehicle's driving elements (the steering wheel and/or gas/brakes pedals) and the corresponding element in the simulator kit has lasted.

In general, any function of the delta over the time can be used as an input to the indicators applying function. Filtering applied over the delta variations can help tuning the reactivity (a.k.a. the nervousness) of the guiding system, taking in account that a too ‘nervous’ guiding system can be annoying to the players.

As related to items 1 and 2 above, instead of estimating the position of the vehicle's steering wheel and gas/brakes pedals, the PU (40) can alternatively estimate the simulated motion parameters induced by the positions of the simulator's steering wheel and gas/brakes pedals. Then the delta between the measured and estimated motions parameters can be used as the input to the indicators applying function.

The PU (40) and the IMU (20) can be enclosed within a shared system case, which is attached by a fastener under the driver's seat (or the front passenger's seat). This corresponds to the embodiment shown in FIG. 1 as an illustrated example.

Alternatively, the PU (40) can be the built-in processor embedded in-car by some car manufacturers for running any other task.

Alternatively, the PU (40) can be embedded in a smartphone or a tablet. In such an embodiment, the PU (40) may or may not be enclosed in the same smartphone or tablet together with the CAM (10) and/or the IMU (20) and/or the U1 (30). All the combinations are possible. In case they are, the data conveyed to the PU (40) within the smartphone or the tablet shall combine and encode together the scenes ahead of the vehicle and/or the instantaneous motion parameters and/or the user's playing actions, respectively.

Alternatively, the PU (40) can be run in a remote server located in a data center far away from the vehicle, and which is accessed through wireless networks such as the cellular phone network.

The PU (40) can be powered from the car battery via a power cable (typically a 12V power cable). It can be turned ON when the car get started and turned OFF when the car is shut down.

The PU (40) unit can alternatively be powered by any independent power source like a set of batteries for instance.

The PU (40) is connected to all the other simulator units via power and data link cables. It was assumed that the PU (40) unit is powering the other units through power and data link cables, but it can be any other unit of the present invention that powers the other units, or any combination of thereof.

Alternatively, each power and data link cable can be entirely or partially replaced by wireless transmitters and/or receivers to reduce the routing of cabling across the vehicle compartment. Any combination of wired and wireless connections can be used between the PU (40) and the other units of the simulator.

The PU (40) embodiments listed above are just examples, and are not excluding the use of any other existing possible embodiment as long as it provides the same basic functionality of processing the streaming video of the scenes ahead of the vehicle (and optionally generating a sound track and inserting indicators) according to the delta between the actions taken by the car driver and those taken by the player.

The visual and/or audio artifacts listed above and referred as indicators are only examples of the indicators that may be applied by the PU (40) on the input streaming video and/or its sound track, and are not excluding the use of any other existing possible indicators as long as they provide the same basic functionality of guiding the player. In general, many other indicators and artifices can be envisaged to be applied on the input streaming video and/or its sound track for making the players understand an action has to be taken for mimic the car driver. The indicators can be of any kind as long as they define an understandable guiding system to the players.

In addition, many other visual and/or audio items can be provided by the PU (40) as necessary, like for instance, configuration and setup screens, display of good/bad points accumulated by a player, etc. or any other item generally present in simulators and video games.

### Monitors

A monitor (50) is placed in front of each passenger, for rear passengers preferably at the rear side of the front seats. It displays the scenes ahead of the vehicle which are constantly captured by the CAM (10), and to which indicators and artifacts were added by the PU (40) in real time.

Like in many today's cars, each rear passenger can be equipped with his/her own LCD monitor that is inserted on the rear side of the driver's seat and of the front passenger's seat.

The streaming video captured by the CAM (10) is processed by the PU (40) in a different manner for each passenger, according to the driving actions taken by him/her with his own user interface (30). It results that the images displayed by two monitors (50) can be slightly different, as per the different visual aids and artifacts added by the PU (40) for each player.

Each monitor (50) is connected to the PU (40) via a power and data link cable.

Alternatively, for reducing the routing of cabling across the vehicle compartment, the power and data link cable running between a monitor (50) and the PU (40) can be entirely or partially replaced by an independent power source for the monitor (50) like a set of batteries for instance, and/or by a wireless transmitter/receiver between the monitor (50) to the PU (40).

The monitor (50) can alternatively be connected to a DVD/USB player like it may exist in some of today's cars. In such a case, a switch can be used to commute between the two possible input streams, either from the DVD/USB or from the PU (40).

Alternatively, the monitor (50) can be embedded in a smartphone or a tablet. In such an embodiment, the monitor (50) may or may not be enclosed in the same smartphone or tablet together with the CAM (10) and/or the IMU (20) and/or the U1 (30) and/or the PU (40). All the combinations are possible. In case it is, the data conveyed to the monitor (50) within the smartphone or the tablet shall combine and encode together the scenes ahead of the vehicle and/or the instantaneous motion parameters and/or the user's playing actions and/or the indicators and other artifacts added by PU (40), respectively.

In case the monitor (50) is not embedded in the same smartphone or tablet than the U1 (30), an in-car smartphone or tablet holder is preferably used to hold it in a fixed position w.r.t. the player.

### Connections of Main Elements and Sub-Elements of Invention

All the elements are connected to the PU (40) via their power and data link cables.

Alternatively, the connecting channels can be made wireless or embedded within the same device (e.g. a smartphone or a tablet), and each element can have its own independent power source like a set of batteries for instance.

### Alternative Embodiments of Invention

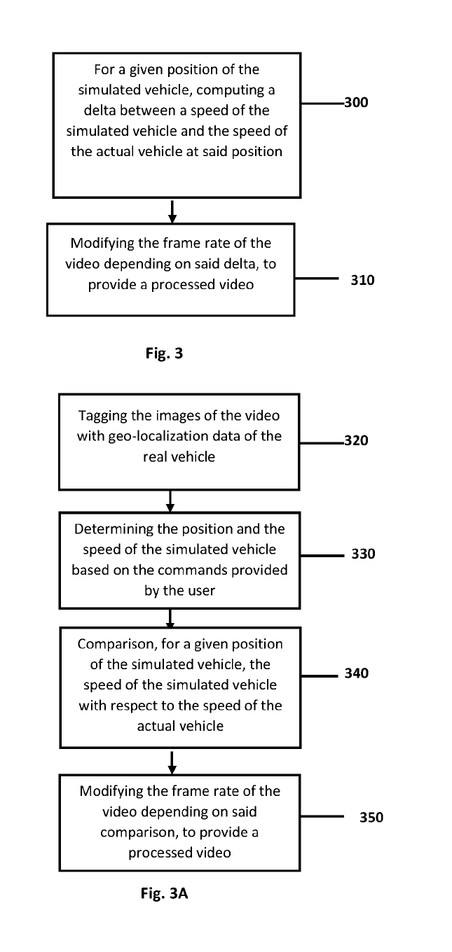

Attention is now drawn to FIG. 3.

As already mentioned, the user of the driving simulator can provide commands through the user interface in order to control the movement of a simulated vehicle.

The video can be processed in order to reflect, on a processed video (see FIG. 2, “modified video stream”) a delta (see reference 300 in FIG. 3) between data representative of controls of the control components (e.g. wheel, pedals, etc.) of the vehicle for controlling the movement of the actual vehicle (these data reflect e.g. speed, position, etc.), and data representative of controls of the user interface for simulating control of the movement of the vehicle (these data reflect e.g. speed, position, etc.).

Data representative of controls of the control components of the vehicle for controlling the movement of the actual vehicle can comprise e.g. position, speed, acceleration, direction of the vehicle. As already mentioned, they can be measured e.g. using various geo-localization devices, and/or using sensors connected to the control components of the vehicle. In some embodiments, speed and/or acceleration can be computed based on the position of the vehicle at each frame, and the time interval between the frames.

Data representative of controls of the user interface for simulating control of the movement of the vehicle comprise e.g. position, speed, acceleration, direction of the simulated vehicle, and can be computed based on the controls provided by the user of the driving simulator using the user interface.

According to some embodiments, the speed of the simulated vehicle (which depends on the commands provided by the user on the user interface, such as the gas pedal) can be different from the speed of the actual vehicle. In particular, a speed of the simulated vehicle at a given position, can be different from the speed of the actual vehicle at this given position, as shown in operation 300 (provided the actual vehicle was indeed at this given position. If this not the case, this can indicate that the simulated vehicle does not follow the same path than the actual vehicle, and thus various other processing can be performed, as described later on, such as shifting of the image, zooming in, etc. to render this difference in the path itself).

According to some embodiments, the frame rate of the video (as received e.g. by the processing unit 40) can be modified depending on this difference (operation 310).

For example, if the speed of the simulated vehicle at a given position is below the speed of the actual vehicle at this given position, which means e.g. that the simulated vehicle is going slower than the actual vehicle at this given position, due to the commands provided by the user through the user interface, the driving simulator can be configured to reduce the frame rate of the processed video with respect to the frame rate of the video provided by the camera.

If the speed of the simulated vehicle at a given position is above the speed of the actual vehicle at this given position, which means e.g. that the simulated vehicle is going quicker than the actual vehicle at this givens position due to the commands provided by the user through the user interface, the driving simulator can be configured to increase the frame rate of the processed video with respect to the frame rate of the video provided by the camera.

According to some embodiments, the modification of the frame rate can comprise the following operations (see FIG. 3A). At least some of these operations can be performed by a processing unit such as processing unit 40.

An operation can comprise associating (operation 320), to each frame of the videos of scenes, or to each subset of frames, geo-localization data of the actual vehicle (geo-localization data of the actual vehicle can be computed using various different techniques, as already explained above). This association can be viewed e.g. as a tagging of each frame with relevant data of the real vehicle.

The geo-localization data can include position of the actual vehicle. Thus, for each frame, or subset of frames, the real position of the actual vehicle is known. These data can be stored e.g. in a memory. As already explained, other data can be computed, such as the speed, the acceleration, the direction of the actual vehicle for each real position. These data can be in some embodiments also associated to each frame.

Another operation can comprise computing (operation 330) a simulated position and the simulated speed of the simulated vehicle in the driving simulation based on the commands provided by the user on the user interface. For example, if the user presses the gas pedal with a given intensity, and/or the brake pedal, and/or changes the direction of the simulated vehicle, the simulated position and the simulated speed of the simulated vehicle can be computed by the processing unit accordingly. According to some embodiments, other data such as the acceleration, the direction of the simulated vehicle can also be computed.

Thus, at a given time t, the position of the simulated vehicle is known. This position can be compared to the list of real positions associated to the frames (which can be obtained as explained with reference to operation 310). If this position matches a real position, then the corresponding speed of the vehicle at this position can be extracted.

As a consequence, it is possible to compare (operation 340), for a given position of the simulated vehicle, the speed of the simulated vehicle (which depends on the commands of the user) with respect to the speed that had the real vehicle at this given position.

Based on this comparison, the frame rate of the processed videos can be adjusted (operation 350). If this comparison indicates that the difference is zero or below a threshold, the frame rate can be maintained equal to the original frame rate.

If this comparison indicates that the speed of the simulated vehicle is below the speed of the actual vehicle at a given position, this can be reflected by lowering the frame rate in the processing videos with respect to the frame rate of the videos of scenes.

Pursuing the previous example, if the user increases later-on the speed of the simulated vehicle at another given position, wherein this increased speed is above the speed of the actual vehicle at this other given position, then the frame rate in the processed videos will be increased with respect to the frame rate of the real videos of scenes. Eventually, when the simulated vehicle will fill-in the gap with the actual vehicle and will adjust its speed to the speed of the actual vehicle, the frame rate in the processed videos can be set equal to the frame rate of the real videos of scenes.

This comparison and this update of the frame rate can be performed for each position of the simulated vehicle, and thus the frame rate can be continuously updated, to reflect the speed difference between the simulated vehicle and the real vehicle at a given position.

The frame rate can also be referred to as the “video playback” (which both reflect the distance in time between two images of the video stream).

The modification of the frame rate can thus produce the effect of a simulated vehicle travelling over the path taken by the real vehicle.

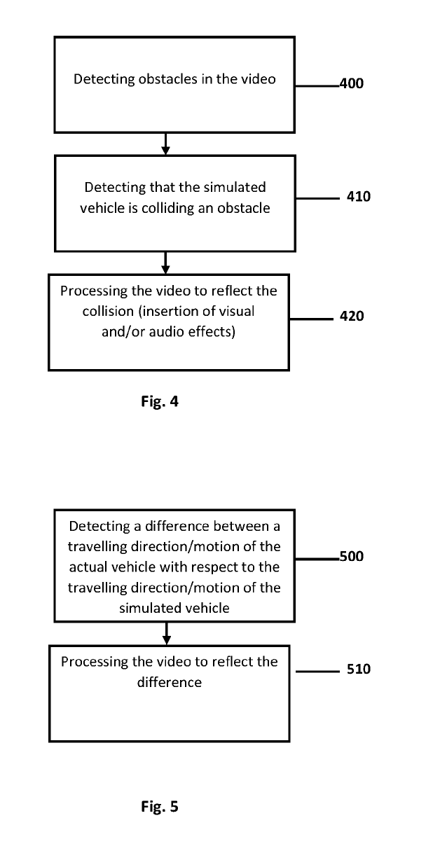

Attention is now drawn to FIG. 4.

According to some embodiments, potential obstacles can be detected in the real video (operation 400). These obstacles can be detected e.g. by the processing unit 40 which can apply image processing unit to the real video. The real video can be segmented into various zones using image processing techniques, and obstacles can be detected.

For examples, obstacles such as trees, road signs, pedestrians, borders of the road, road edge items, another vehicle present on the road, etc. (these examples are not limitative) can be detected.

Since these obstacles are detected, their absolute position and/or their position in the referential of the image can be computed. Indeed, as already mentioned (see operation 320), the position of the vehicle at which image was taken by the camera mounted on the vehicle can be computed using geo-localization devices present on the vehicle (as already mentioned above).

The processing unit can compare the simulated position of the simulated vehicle (which can be computed as explained with operation 330) with the position of the obstacle.

If these two positions match, according to some matching criterion (e.g. their difference is below a predefined threshold), then this indicates that the simulated vehicle has collided the obstacle (operation 410). The real video can be processed to reflect this collision (operation 420). In particular, various image and/or audio effects can be added to the video in order to a produce a processed video reflecting this scenario. For example, an image of a crash can be superimposed on the real video (e.g. by adding fire, shards in the real video). In some embodiments, audio effects can be added to simulate the crash.

According to some embodiments, the intensity of the visual effects and/or audio effects can be selected to reflect the intensity of the collision (which can be estimated using e.g. the speed of the simulated vehicle, the size of the obstacles, their nature, etc.)

The collision with an obstacle is only an example and various other scenarios can be simulated.

According to some embodiments, the processing can be performed in real time or in quasi real time (with a delay below a threshold).

A driving experience of a virtual vehicle over a real time video is thus obtained, which can be adapted to obstacles and elements present in the real time video.

Attention is now drawn to FIG. 5.

As already mentioned above, a delta between data representative of controls of the control components of the vehicle for controlling the actual movement of the vehicle, and data representative of controls of the user interface for simulating control of the movement of the vehicle can be computed.

In particular, according to some embodiments, a travelling direction of the actual vehicle can be compared with a travelling direction of the simulated vehicle (operation 500). According to some embodiments, a travelling motion of the actual vehicle can be compared with a travelling motion of the simulated vehicle (operation 500). This comparison can rely on some of the operations described in FIG. 3A. In particular, the simulated position of the vehicle is known, and the real position of the vehicle associated to each frame is known (as explained in FIG. 3A). When at a given position, it is detected that the travelling motion or direction of the simulated vehicle is not compliant with the travelling motion or direction of the actual vehicle, then operations such as shifting can be performed to reflect this difference (on the relevant frames).

The travelling direction/motion of the actual vehicle can be computed based e.g. on geo-localization devices and/or based on the commands provided by the actual driver on the control components of the vehicle.

According to some embodiments, it can be detected that the simulated vehicle, due to commands of the user, is overtaking a car on the right side, whereas the actual vehicle is overtaking the car on the left side.

The presence of the car can be detected by using image recognition techniques.

Similarly, it can be detected that the simulated vehicle, due to commands of the user, is moving from a first road lane to a second road lane, wherein this change is going from the left side to the right side of the image, whereas the actual vehicle is moving from the second road lane to the first road lane (this motion is going from the right side to the left side of the image).

Various discrepancies (“delta”) can be detected between the actual motion of the actual vehicle and the simulated motion of the simulated vehicle, and this delta can be reflected in the processed video.

In particular, the real time video can be processed to reflect at least one of:
the fact that the simulated vehicle is travelling on a road lane different from the actual road lane of the actual vehicle;
the fact that the simulated vehicle is moving from a first road lane to a second road lane, whereas the actual vehicle does not change lane, or changes its road lane in a different direction;
the fact that the simulated vehicle is overtaking a vehicle present in the video, whereas the actual vehicle does not change overtake this vehicle, or does not overtake any vehicle.

Reflection of these differences can comprise various processing methods.

According to some embodiments, deletion of elements present in the real time video can be performed. For example, vehicles and/or obstacles present in the real time video can be deleted.

According to some embodiments, addition of elements in the real time video can be performed. For example, vehicles and/or obstacles can be added in the real time video.

According to some embodiments, rotation, mirror effect, symmetrical transformation, translation, etc. of the image can be applied to reflect these differences.

According to some embodiments, if the actual vehicle is overtaking a given vehicle by the left, and the simulated vehicle is overtaking the given vehicle by the right, a right side-view of the given vehicle can be computed and displayed (this right side-view can be computed based on the left side-view of the given vehicle captured in the real time video, and since the given vehicle is assumed to be symmetric, the left side-view can be computed by replicating and rotating the right side-view).

The various processing described above can also be performed using some of the operations of FIG. 3A. In particular, the simulated position of the vehicle is known, and the real position of the vehicle associated to each frame is known (as explained in FIG. 3A). When at a given position of the simulated vehicle it is detected that the motion of the simulated vehicle differs from the motion of the real vehicle at this given position, processing as described above can be performed, to process the corresponding relevant frames and output them.

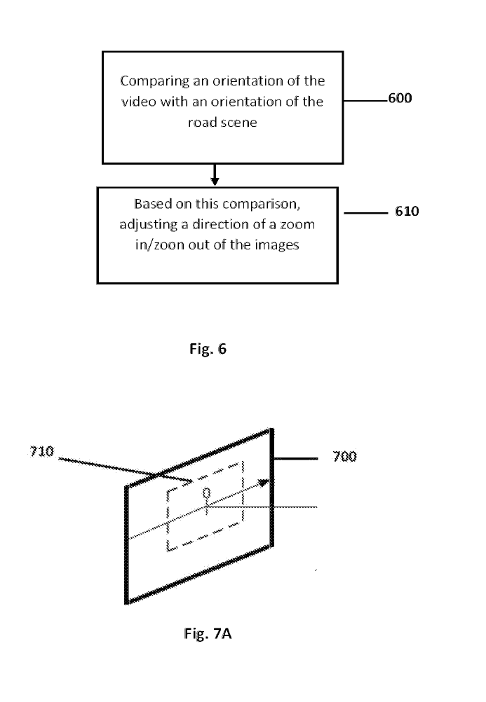

Attention is now drawn to FIG. 6.

It has already been mentioned that according to some embodiments, the real time video can be processed so that a zoom-in, or zoom-out, can be applied.

According to some embodiments, a smart zoom can be applied.

Indeed, the direction and/or orientation of the camera is not always necessarily aligned with the relevant parts of the road scene. Thus, for example when a zoom-in is applied, it can happen that the zoomed image will be an image of the sky, instead of the road, due to this misalignment.

An operation 600 can comprise comparing an orientation of the video with an orientation of the road scene, or of relevant parts of the road scene (such as road lanes, borders, obstacles, etc.), in order to detect the direction in which the relevant parts of the road scene are located.

When a zoom in or zoom out is applied, an operation 610 can comprise adjusting the direction of the zoom based on this comparison. Thus, the zoom can be adjusted to be oriented towards relevant portions of the road scene, or to be maintained in alignment with the road view.

According to some embodiments, a shifting of the images can be performed. This shifting can be computed based on a data representative of controls of the control components of the vehicle for controlling the actual movement of the vehicle, and data representative of controls of the user interface for simulating control of the movement of the vehicle. In particular, this shifting can be performed based on a comparison between a direction of the simulated vehicle with respect to a direction of the actual vehicle.

For example, if the actual vehicle is driving in a straight line, and the simulated vehicle is turning in a right direction, a shift of the image in the right direction can be performed to reflect this delta. If the simulated pursues its path towards this wrong direction, a zoom-in of the images can be produced to give the impression that the simulated vehicle is moving forwards (until the simulated vehicle reaches a limit, since videos of the scenes will not be present in this direction, except if communication with other driving simulators is performed, as explained later).

Other embodiments will be described in which the shift operation can be combined with other processing techniques.

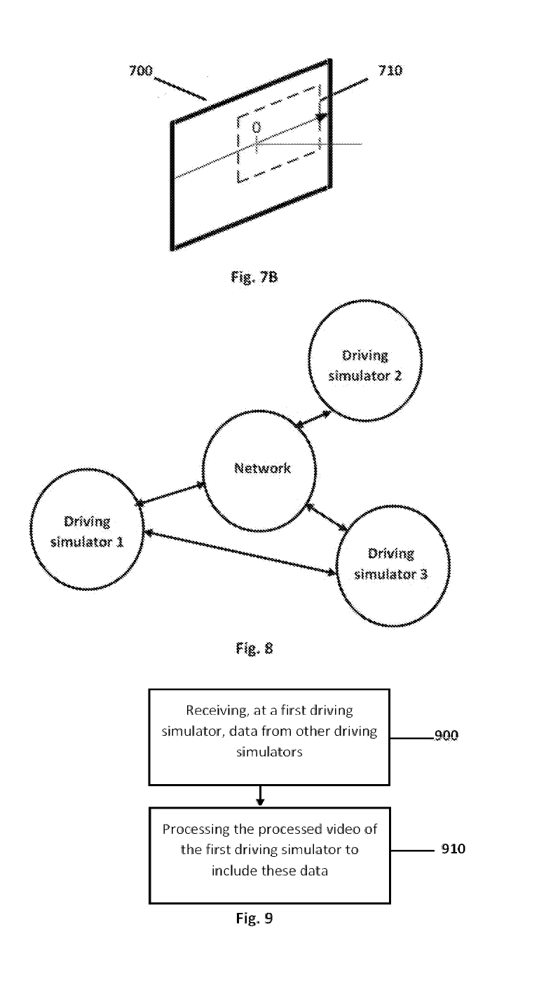

This is shown in FIGS. 7A and 7B.

In FIG. 7A, the actual video 700 and the processed video 710 are shown. In FIG. 7B, a shift is performed by displaying a processed video 710 which is shifted with respect to the actual video 700, to reflect a delta in the motion or travelling direction between the actual vehicle and the simulated vehicle.

The various processing described above can also be performed using some of the operations of FIG. 3A. In particular, the simulated position of the vehicle is known, and the real position of the vehicle associated to each frame is known (as explained in FIG. 3A). When at a given position of the simulated vehicle it is detected that the travelling motion or direction of the simulated vehicle differs from the travelling motion or direction of the real vehicle at this given position, processing as described above can be performed to process the corresponding relevant frames and output them (such as by shifting them).

According to some embodiments, advertisement present in the real time video (such as on-road ads banners) can be detected, using image processing techniques, and replaced in the processed video by other images. In some embodiments, the advertisement are replaced with images which match a profile of the user of the driving simulator. For example, if the user is a kid, the advertisement can be replaced by advertisement which match the age of the user.

According to some embodiments, the processing can be performed in real time or in quasi real time (with a delay below a threshold).

Attention is now drawn to FIG. 8.

As shown, a network of a plurality of driving simulators can be built which can exchange data. These data can include e.g. localization data of the real vehicle, commands provided by the users of the driving simulators, actual commands provided by the actual drivers, etc.

According to some embodiments, the driving simulators can exchange data through a network and/or through a cloud.

According to some embodiments, the driving simulators can exchange data directly one with the other, without using the cloud.

Attention is now drawn to FIG. 9.

According to some embodiments, the processed video can incorporate data of processed videos provided by other driving simulators (see operations 900, 910).

Assume a first driving simulator provides a first processed video in which a first simulated vehicle is moving in a first geographical zone. Assume a second driving simulator provides a second processed video in which a second simulated vehicle is moving in a second geographical zone, wherein the first and second zone intersect.

According to some embodiments, the first driving simulator can receive the data of the second driving simulator and can process the first processed video to display the second simulated vehicle within the first processed video. Thus, depending on the commands provided to the second driving simulator, the second simulated vehicle will change its position or motion within the first processed video of first driving simulator (and also within the second processed video). This can be applied also conversely.

This can be applied to N driving simulators.

All the techniques described above can be applied to this second simulated vehicle. For example collision with the second simulated vehicle can be simulated, as explained above with reference to FIG. 4.

Thus, a mix of real elements (from the real video), real elements which have been processed (such as obstacles, elements, other vehicles which can be displaced, replicated, deleted etc.) and purely simulated elements can be all at the same time be included in a given processed video, in real time or quasi real time.

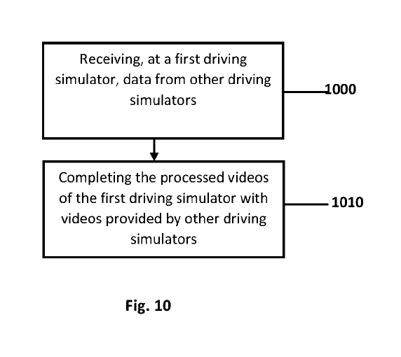

Attention is now drawn to FIG. 10 (see operations 1000, 1010).

In some embodiments, when a first simulated vehicle is going quicker than the actual vehicle, and/or when the first simulated vehicle is at a position which is beyond the images which are available from the real time videos, then the question is how to create a realistic driving since the real time videos are not available.

According to some embodiments, the driving simulator can receive data from at least one second driving simulator which is mounted on a vehicle which is located at this position and which is currently obtaining images at this position from its camera, or which was located at this position at a previous time slot and has captured corresponding images at this position.

The processed videos of the first driving simulator can be processed to display the videos captured by the second driving simulator (e.g. the real time video, or the processed videos of the second driving simulator).

Thus, even if the first driving simulator does not have access to these images by itself, it can complete its processed videos by benefiting from the images captured and transmitted to another driving simulator, which is useful.

According to some embodiments, a plurality of the techniques described above can be combined, thus providing a realistic driving experience to the user.

For example, a combination of a slower playback speed (frame rate), shifting and zooming over the video images can be performed to render a simulated vehicle that deviates from the real car's path.

This is not limitative and various other combinations can be performed.

What has been described and illustrated herein are the preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

A variant of the present invention can use a pre-recorded video of the vehicle front scenes captured at another driving session by the same or by another vehicle. The car passengers will then have to mimic the pre-recorded driving session while being driven for another trip. This may be useful for instance when the present trip does not offer interesting front scenes.

In addition to the indicators listed before, the PU (40) can insert into the image front scenes the rear scenes of the vehicle, like would do a rear view mirror. The rear scenes can be captured by another video cam directed toward the rear of the vehicle, and connected to the PU (40) via one of the means listed for the front view video cam.

Any of the foregoing embodiments are innovative in that it provides a real time car driving simulator that entertains the passengers of a vehicle, while at the same time, keeps them connected with the surrounding landscapes. Also, the embodiments provide a real time car driving simulator that gives passengers the pleasant feeling that they are driving the vehicle at the driver's seat. Even further, the embodiments provide a real time car driving simulator that prevents nausea to the passengers of a car. An embodiment is also advantageous because it provides a real time car driving simulator for the learning of car driving while not being currently the driver of the vehicle, as a complement (or in advance) to car driving lessons. The simulator is based on an augmented reality for providing to the user an experience very close to real life road conditions.

In another embodiment of the invention, it is possible that the processing unit (40), the IMU (20), the CAM (10), the monitor (50) and possibly also the user interface (30) are part of a vehicle when manufactured. One or more of these components, or possibly even all of these components, may be built into the vehicle by the manufacturer. Thus, a simulator in accordance with the invention may be a feature of a vehicle when sold. In addition, the invention could be a computer program resident at the PU (40) to coordinate receipt of and process input from the CAM (10), the IMU (20) and the user interface (30), and generate output for the monitor (50). Such a computer program could be downloaded into the PU (40).

Other objects and advantages of the present invention are or will become obvious to the reader in view of the disclosure herein and it is intended that these objects and advantages are within the scope of the present invention. To accomplish the above and related objects, this invention may be embodied in the form illustrated in the accompanying drawings, attention being called to the fact, however, that the drawings are illustrative only, and that changes may be made in the specific construction illustrated and described within the scope of this application.

What is claimed is:

1. A driving simulator, comprising:
a processing unit;
wherein said processing unit is coupled to a video camera arranged on an actual vehicle and that provides videos of scenes in front of the actual vehicle to said processor; wherein said actual vehicle is controllable by control components,
wherein said processing unit is configured to process said videos of scenes into processed videos,
wherein said processing unit is coupled to a monitor, said monitor being configured to display said processed videos,
wherein said processing unit is coupled to a user interface, said user interface being configured to enable simulating control of a movement of the actual vehicle based on processed videos displayed by the monitor,
wherein said processed videos reflect a delta between data (DREAL) representative of controls of the control components of the actual vehicle for controlling the movement of actual the vehicle, and data representative of controls of said user interface for simulating control of the movement of the actual vehicle (DSIM),
wherein the processing unit is configured to:
associate to each frame or subset of frames of the videos of scenes a real position and a real speed of the actual vehicle,
if DSIM are representative of a simulated position of the actual vehicle which correspond to a real position of the actual vehicle, compare a simulated speed of the actual vehicle with a real speed of the simulated vehicle at said simulated position, and
based on this comparison, modify the frame rate of the videos of scenes to provide said processed videos.

2. The driving simulator of claim 1, wherein the processing unit is configured to perform at least one of zooming in the videos of scenes and zooming out the videos of scenes depending on said delta.

3. The driving simulator of claim 1, wherein the processing unit is configured to adjust a direction of zooming based on a detection of road portions in the videos of scenes.

4. The driving simulator of claim 1, wherein the processing unit is configured to detect advertisement present in the videos of scenes, and to replace them in the processed videos by other images depending on a profile associated to a user of the driving simulator.

5. The driving simulator of claim 1, wherein the driving simulator is configured to obtain data from a second driving simulator, wherein the driving simulator is configured to complete the processed videos with video of scenes provided by the second driving simulator located in a zone comprising said simulated position.

6. The driving simulator of claim 1, wherein the driving simulator is configured to obtain data from a second driving simulator, wherein the driving simulator is configured to display a simulated vehicle in the processed videos based on said data and reflecting a simulated vehicle associated to said second driving simulator.

7. A driving simulator, comprising:
a processor;
wherein said processor is coupled to a video camera arranged on an actual vehicle and that provides videos of scenes in front of the actual vehicle to said processor; wherein said actual vehicle is controllable by control components,
wherein said processor is configured to process said videos of scenes into processed videos,
wherein said processor is coupled to a monitor, said monitor being configured to display said processed videos,
wherein said processor is coupled to a user interface, said user interface being configured to enable simulating control of a movement of the actual vehicle based on processed videos displayed by the monitor,
wherein said processed videos reflect a delta between data (DREAL) representative of controls of the control components of the actual vehicle for controlling the movement of the actual vehicle, and data representative of controls of said user interface for simulating control of the movement of the actual vehicle (DSIM), wherein the processing unit is configured to detect one or more potential obstacles present in the videos of scenes,
wherein if DSIM are associated with a simulated position of the actual vehicle which corresponds to a position of at least one of the detected obstacles, the processing unit is configured to integrate within the processed videos a simulation of a collision with said at least one detected obstacles.

8. The driving simulator of claim 7, wherein:
if condition (i), (ii) or (iii) is met,
(i) DSIM are associated with a simulated motion on a road lane different from an actual road lane on which the actual vehicle is travelling;
(ii) DSIM are associated with a simulated motion from a first road lane to a second road lane, whereas the actual vehicle does not change its road lane, or changes its road lane in a different way;
(iii) DSIM are associated with a simulated motion comprising overtaking a vehicle present in the videos of scenes, whereas the actual vehicle is not overtaking this vehicle,
the processing unit is configured to modify the videos of scenes in order to produce said processed videos, said modification comprising reflecting, using image processing techniques, in the processed videos, said condition (i), (ii), or (iii).

9. The driving simulator of claim 7, wherein the driving simulator is configured to obtain data from a second driving simulator, wherein the driving simulator is configured to display a simulated vehicle in the processed videos based on said data and reflecting a simulated vehicle associated to said second driving simulator.

10. The driving simulator of claim 7, wherein the processing unit is configured to perform at least one of zooming in the videos of scenes and zooming out the videos of scenes depending on said delta.

11. The driving simulator of claim 7, wherein the processing unit is configured to adjust a direction of zooming based on a detection of road portions in the videos of scenes.

12. The driving simulator of claim 7, wherein the processing unit is configured to detect advertisement present in the videos of scenes, and to replace them in the processed videos by other images depending on a profile associated to a user of the driving simulator.

13. A driving simulator, comprising:
a processor;
wherein said processor is coupled to a video camera arranged on an actual vehicle and that provides videos of scenes in front of the actual vehicle to said processor; wherein said actual vehicle is controllable by control components,
wherein said processor is configured to process said videos of scenes into processed videos,
wherein said processor is coupled to a monitor, said monitor being configured to display said processed videos,
wherein said processor is coupled to a user interface, said user interface being configured to enable simulating control of a movement of the actual vehicle based on processed videos displayed by the monitor,
wherein said processed videos reflect a delta between data (DREAL) representative of controls of the control components of the actual vehicle for controlling the movement of the actual vehicle, and data representative of controls of said user interface for simulating control of the movement of the actual vehicle (DSIM), wherein the processing unit is configured to detect one or more potential obstacles present in the videos of scenes,
wherein the driving simulator is configured to exchange data with a second driving simulator, and
wherein if DSIM are associated with a simulated position of the actual vehicle which correspond to scenes which are not currently available in said videos of scenes, the driving simulator is configured to complete the processed videos with data provided by the second driving simulator.

14. The driving simulator of claim 13, wherein:
if condition (i), (ii) or (iii) is met,
(i) DSIM are associated with a simulated motion on a road lane different from an actual road lane on which the actual vehicle is travelling;
(ii) DSIM are associated with a simulated motion from a first road lane to a second road lane, whereas the actual vehicle does not change its road lane, or changes its road lane in a different way;
(iii) DSIM are associated with a simulated motion comprising overtaking a vehicle present in the videos of scenes, whereas the actual vehicle is not overtaking this vehicle,
the processing unit is configured to modify the videos of scenes in order to produce said processed videos, said modification comprising reflecting, using image processing techniques, in the processed videos, said condition (i), (ii), or (iii),

15. The driving simulator of claim 13, wherein if DSIM are associated with a simulated motion comprising overtaking a given vehicle present in the videos of scenes on a first side, and the actual vehicle is overtaking this given vehicle on an second side different from the first side, the driving simulator is configured to simulate in the processed videos a view of the given vehicle on the first side based on the view of the given vehicle on the second side.

16. The driving simulator of claim 13, wherein the driving simulator is configured to obtain data from a second driving simulator, wherein the driving simulator is configured to display a simulated vehicle in the processed videos based on said data and reflecting a simulated vehicle associated to said second driving simulator.

17. The driving simulator of claim 13, wherein the processing unit is configured to perform at least one of zooming in the videos of scenes and zooming out the videos of scenes depending on said delta.

18. The driving simulator of claim 13, wherein the processing unit is configured to adjust a direction of zooming based on a detection of road portions in the videos of scenes.

19. The driving simulator of claim 13, wherein the processing unit is configured to detect advertisement present in the videos of scenes, and to replace them in the processed videos by other images depending on a profile associated to a user of the driving simulator.

20. The driving simulator of claim 13, configured to perform at least one of:
shifting right the videos of scenes,
shifting left the videos of scenes,
shifting up the videos of scenes,
shifting down the videos of scenes, and
inserting indicators on the videos of scenes.
